(19) United States
(12) Patent Application Publication
(10) Pub. No.: US 2007/0230764 A1
(43) Pub. Date: Oct. 4, 2007

(54) Fast generation of digitally reconstructed radiographs

(76) Inventors: Ali Khamene, Princeton, NJ (US); Frank Sauer, Princeton, NJ (US)

Correspondence Address: Siemens Corporation;Intellectual Property Department, 170 Wood Avenue South, Iselin, NJ, 08830, US

(21) Appl. No.: 10/951,167

(22) Filed: Sep. 27, 2004

Related U.S. Application Data
(60) Provisional application No. 60/561,185, filed on Apr. 9, 2004.

(51) Int. Cl. G06K 9/00

(52) U.S. Cl. 382/132

(57) ABSTRACT

A system and corresponding method for fast generation of digitally reconstructed radiograph (DRR) images are provided, the system including a processor, an imaging adapter in signal communication with the processor for receiving volumetric data, a preprocessing unit in signal communication with the processor for preprocessing subvolumes into a set of local line integrals, and an online processing unit in signal communication with the processor for online processing global line integrals, each from a set of local line integrals, respectively; and the corresponding method including receiving three-dimensional volumetric data, subdividing the volumetric data into a set of overlapping subvolumes, preprocessing each subvolume into a dense set of local line integrals at several angles and positions, online processing global line integrals, each from a set of local line integrals, respectively, and adding up values of the set of local line integrals for each global line integral to form pixels of the DRR image.

### CROSS-REFERENCE TO RELATED APPLICATION

The present application claims the benefit of U.S. Provisional Application Ser. No. 60/561,185 (Attorney Docket No. 2004P06012US), filed Apr. 9, 2004 and entitled “Fast DRR Generation Algorithm Using Pre-computed Fragmented Line Integrals”, which is incorporated herein by reference in its entirety.

### BACKGROUND

Digitally Reconstructed Radiographs (DRRs) are simulated two-dimensional (2D) X-ray or portal transmission images, which are computed from three-dimensional (3D) datasets such as computed tomography (CT), megavoltage computed tomography (MVCT), 3D imaging of high contrast objects using rotating C-arms, and the like. DRRs have many uses in the diagnosis, therapy and treatment workflows, such as in patient positioning for radiotherapy, augmented reality, and/or 2D to 3D registration between pre-surgical data and intra-surgical fluoroscopic images.

DRRs are commonly generated by casting rays through the volumetric datasets and by integrating the intensity values along these rays, which is typically accomplished after passing the intensities through a lookup table that models ray-tissue interactions. Unfortunately, this process is prohibitively slow for real-time or near real-time applications.

There are approaches proposed in the literature that attempt to address this problem. Representations called Transgraphs and Lumigraphs have been suggested.

A Transgraph is an intermediate data representation. The Transgraph is a huge parameterized space of pre-computed DRRs projection lines. In an online mode, the DRRs are generated by finding the correct set of pre-computed line integrals.

A Lumigraph uses Light Field based DRRs. The Lumigraph algorithm includes pre-computation of rays connecting two planes, but differs in its method of parameterizing the pre-computed line integrals. DRRs are then generated by finding the closest pre-computed ray for each DRR pixel. An interpolation of pre-computed rays was shown for the Lumigraph, but it was not a mathematically correct procedure.

These prior approaches speed up computation of DRRs by an order of magnitude as compared to ray-casting techniques, without the use of special graphics hardware. However, there are many drawbacks to such approaches. One significant drawback is that a large amount of memory is required to store the pre-computed data. Another significant drawback is that the quality of the synthesized DRRs is poor for the views and rays that have not been pre-computed and stored in the database.

Accordingly, what is needed is a system and method for fast generation of digitally reconstructed radiographs. The present disclosure addresses these and some other issues.

### SUMMARY

These and other drawbacks and disadvantages of the prior art are addressed by a system and method for fast generation of digitally reconstructed radiographs.

A system for fast generation of digitally reconstructed radiograph (DRR) images is provided, including a processor, an imaging adapter in signal communication with the processor for receiving volumetric data, a preprocessing unit in signal communication with the processor for preprocessing subvolumes into a set of local line integrals, and an online processing unit in signal communication with the processor for online processing global line integrals, each from a set of local line integrals, respectively.

A corresponding method for fast generation of DRR images is provided, including receiving three-dimensional volumetric data, subdividing the volumetric data into a set of overlapping subvolumes, preprocessing each subvolume into a dense set of local line integrals at several angles and positions, online processing global line integrals, each from a set of local line integrals, respectively, and adding up values of the set of local line integrals for each global line integral to form pixels of the DRR image.

These and other aspects, features and advantages of the present disclosure will become apparent from the following description of exemplary embodiments, which is to be read in connection with the accompanying drawings.

### BRIEF DESCRIPTION OF THE DRAWINGS

The present disclosure teaches a system and corresponding method for fast generation of digitally reconstructed radiographs, in accordance with the following exemplary figures, in which:

FIG. 1 shows a schematic diagram of a system for fast generation of digitally reconstructed radiographs in accordance with an illustrative embodiment of the present disclosure;

FIG. 2 shows a flow diagram of a method for fast generation of digitally reconstructed radiographs in accordance with an illustrative embodiment of the present disclosure; and

FIG. 3 shows a schematic diagram of an apparatus for fast generation of digitally reconstructed radiographs in accordance with an illustrative embodiment of the present disclosure.

### DETAILED DESCRIPTION OF PREFERRED EMBODIMENTS

In accordance with exemplary embodiments of the present disclosure, a system and a method for fast generation of digitally reconstructed radiographs using pre-computed fragmented line integrals are disclosed herein. The embodiments exemplify a novel approach for generating digitally reconstructed radiographs (DRRs). DRRs are projection images, which are computed from volumetric data such as magnetic resonance (MR) or computed tomography (CT) images, for example. The presently disclosed approach includes computation of line integrals through a three-dimensional (3D) volume, and connection of the source location to each pixel in the imaging plane.

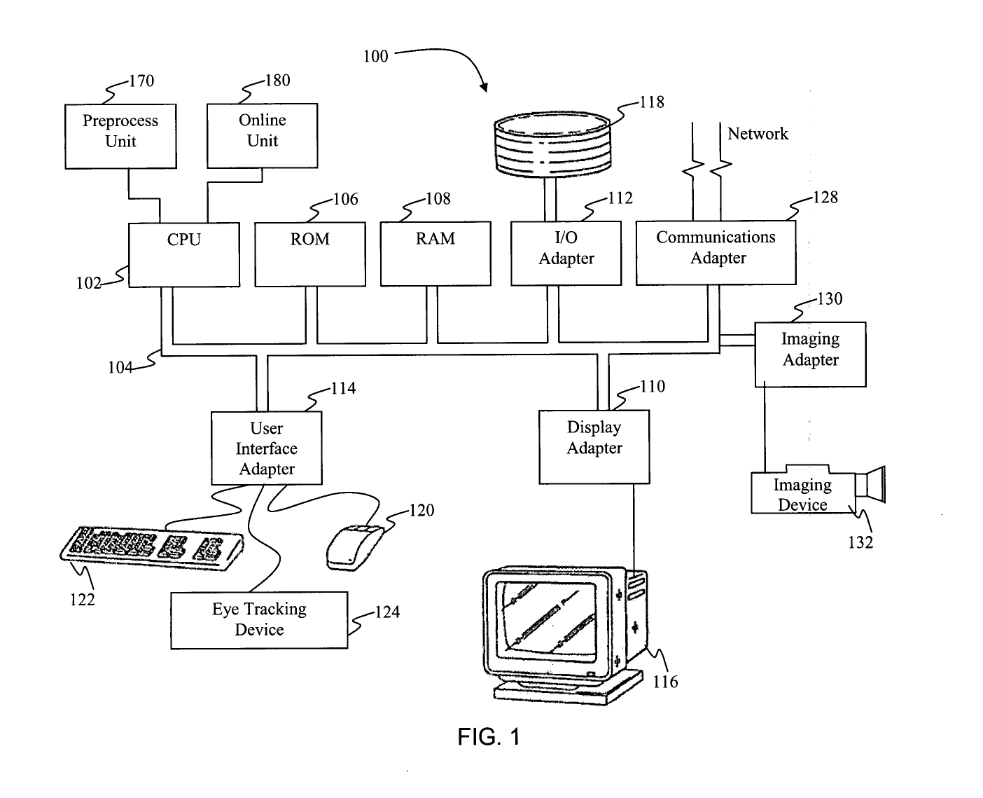

As shown in FIG. 1, a system for fast generation of digitally reconstructed radiographs according to an illustrative embodiment of the present disclosure is indicated generally by the reference numeral 100. The system 100 includes at least one processor or central processing unit (“CPU”) 102 in signal communication with a system bus 104. A read only memory (“ROM”) 106, a random access memory (“RAM”) 108, a display adapter an I/O adapter 112, a user interface adapter 114, a communications adapter 128, and an imaging adapter 130 are also in signal communication with the system bus 104. A display unit 116 is in signal communication with the system bus 104 via the display adapter 110. A disk storage unit 118, such as, for example, a magnetic or optical disk storage unit is in signal communication with the system bus 104 via the I/O adapter 112. A mouse 120, a keyboard 122, and an eye tracking device 124 are in signal communication with the system bus 104 via the user interface adapter 114. A magnetic resonance imaging device 132 is in signal communication with the system bus 104 via the imaging adapter 130.

A preprocessing unit 170 and an online unit 180 are also included in the system 100 and in signal communication with the CPU 102 and the system bus 104. While the preprocessing unit 170 and the online unit 180 are illustrated as coupled to the at least one processor or CPU 102, these components are preferably embodied in computer program code stored in at least one of the memories 106, 108 and 118, wherein the computer program code is executed by the CPU 102. As will be recognized by those of ordinary skill in the pertinent art based on the teachings herein, alternate embodiments are possible, such as, for example, embodying some or all of the computer program code in registers located on the processor chip 102. Given the teachings of the disclosure provided herein, those of ordinary skill in the pertinent art will contemplate various alternate configurations and implementations of the preprocessing unit 170 and the online unit 180, as well as the other elements of the system 100, while practicing within the scope and spirit of the present disclosure.

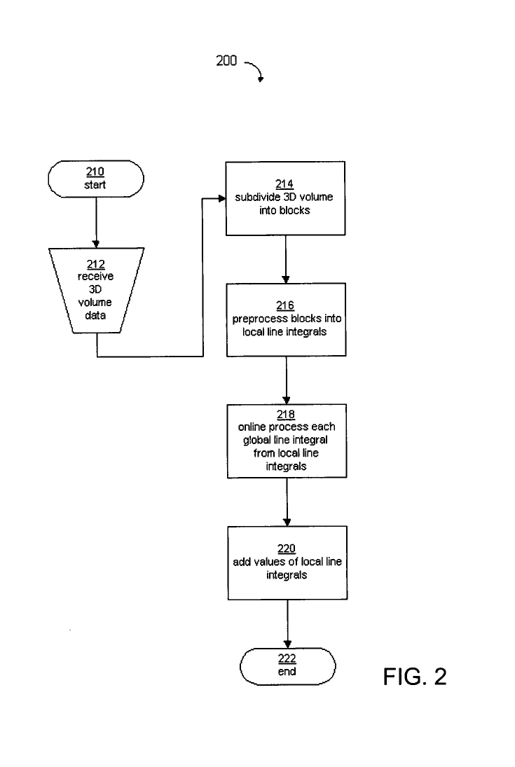

Turning to FIG. 2, a method for fast generation of digitally reconstructed radiographs according to an illustrative embodiment of the present disclosure is indicated generally by the reference numeral 200. The method 200 includes a start block 210 that passes control to an input block 212. The input block 212 receives 3D volume data, and passes control to a function block 214. The function block 214 subdivides the 3D volume into a set of overlapping subvolumes or blocks, and passes control to a function block 216. The function block 216 preprocesses these subvolumes of the 3D volume into a dense set of local line integrals at various angles and positions, and passes control to a function block 218. The function block 218 performs online processing in which each global line integral is pieced together from a set of local line integrals, and passes control to a function block 220. The function block 220, in turn, adds up the values of the appropriate local line integrals as stored in a precomputed look-up table, and passes control to an end block 222.

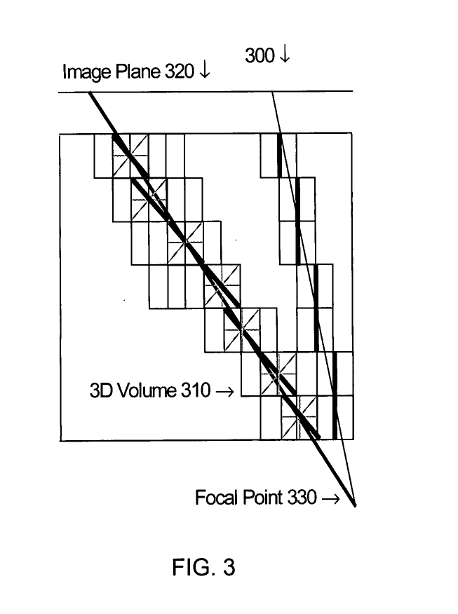

Turning now to FIG. 3, an apparatus for fast generation of digitally reconstructed radiographs according to an illustrative embodiment of the present disclosure is indicated generally by the reference numeral 300. The apparatus 300 includes a three-dimensional (3D) volume 310, an image plane 320, and a focal point 330. The thick lines represent fragments chosen out of the ones represented by thin lines that are computed for each block. An alternate approach is to interpolate between the line pre-computed fragmented line integrals, to estimate the local line integral at any given direction.

In operation, this novel approach for generating digitally reconstructed radiographs (DRRs) is very fast and does not suffer from prior drawbacks. DRRs are projection images, which are computed from volumetric data such as magnetic resonance (MR) or computed tomography (CT) images. The process involves computation of the line integrals through the 3D volume, and connecting the source location to each pixel in the imaging plane.

Exemplary method embodiments include the following steps. The 3D volume is subdivided into a set of overlapping subvolumes or blocks. In the preprocessing step, a dense set of local line integrals at various angles and positions are computed for these blocks of the 3D volume. The size and amount of overlapping for the subvolumes are variables affecting the pre-computation data or look-up table size and overall quality of the generated DRRs. In the online step, each global line integral is pieced together from a set of local line integrals, adding up the values of the appropriate local line integrals as stored in the precomputed look-up table. An interpolation technique may be used to acquire the local integrals at angles that have not been pre-computed. The online computation load will be effectively decreased, comparable to the computation gain that one would get by downsampling the original volume. However, the quality of the generated DRR is much better compared to DRRs merely obtained from a downsampled volume since directional information is still included in the pre-calculated local line integrals. The quality of the generated DRRs in the new method depends on the density of the pre-computed local line integrals as well as the degree of downsampling or the size of the overlapping cubes.

Preferably, the interpolation between the local line integral should happen prior to summing up the fragments to get the pixel value of the DRR image. The interpolated value need not be stored in the look-up table. A non-uniform partitioning of the volume based on the voxel intensity gradient promotes denser sampling of the local line integrals for the areas of the volume where there is a large intensity gradient, and coarser sampling for the uniform areas. Here, sampling can be translated to 1) the size of the cube for the local line integral, 2) the number of the directions for which the local line integral is computed, and 3) the amount of overlapping between the cubes.

Thus, a method for pre-computation of local line integrals is disclosed that can be used effectively to construct DRRs for various viewpoints. The exemplary embodiment does not pre-compute complete DRRs or rays from a variety of viewpoints in advance and then interpolate between them for new views, but pre-computes building blocks of DRRs and assembles them in the on-line mode for arbitrary DRRs generation. For example, a volume with the size 512×512×512 can be subdivided into 16×16×16 blocks with overlaps of four pixels in each direction. This would effectively give 128×128×128 blocks. If for each block, 4×4×4 local line integrals are computed, the original size of the data would not be exceeded. However, any DRR can be generated using the new 128×128×128 data representation of the volume, which makes the online DRR generation up to 64 times faster compared to the prior ray casting method.

An exemplary DRR generation algorithm includes a pre-processing stage, which divides the volumetric image into overlapping sub-volumes, generates a set of local line integrals for various directions within each sub-volume, and stores the pre-computed local line integrals in a look-up table. In the online stage, for each pixel in the DRR image, the line integral is formed by piecing together the closest local line integrals stored in the look-up table.

Preferably, the local line integrals are not uniformly spaced in 3D space. It is usually known from which direction the source has been radiating onto the volume for the 3D image acquisition, therefore it will be more efficient that line integrals are sampled more densely in that general direction. The amounts of overlapping between the blocks need not be identical in all directions. The amount of overlapping may be increased in the primary direction perpendicular to the general direction of the rays.

In one exemplary embodiment, the line integral fragments are stored in form of textures within the graphics hardware, and the algorithm is implemented using the graphics hardware capabilities. The values of the local line integrals may also be stored as textures within the graphics hardware for hardware accelerated DRR generation. Graphics Processing Units may be used.

The positions and sizes of the subvolumes are preferably adapted to the properties of the volumetric data. The hierarchy of blocks with various sizes and overlap amounts are pre-computed and used for DRR reconstructions. Such algorithms can be used for rendering transparent volumes. In addition, each line integral may be pieced together by interpolating the pre-computed local line integrals first among the neighboring subvolumes, and second among the neighboring directions within a subvolume.

These and other features and advantages of the present disclosure may be readily ascertained by one of ordinary skill in the pertinent art based on the teachings herein. It is to be understood that the teachings of the present disclosure may be implemented in various forms of hardware, software, firmware, special purpose processors, or combinations thereof.

Most preferably, the teachings of the present disclosure are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. All such changes and modifications are intended to be included within the scope of the present disclosure as set forth in the appended claims.

What is claimed is:

1. A method for fast generation of digitally reconstructed radiograph (DRR) images, the method comprising:
receiving three-dimensional (3D) volumetric data;
subdividing the 3D volumetric data into a set of overlapping subvolumes;
preprocessing each subvolume into a dense set of local line integrals at a plurality of angles and positions;
online processing global line integrals, each from a set of local line integrals, respectively; and
adding up values of the set of local line integrals for each global line integral to form pixels of the DRR image.

2. A method as defined in claim 1 wherein the values of the set of local line integrals are stored in a pre-computed look-up table.

3. A method as defined in claim 1, the step of preprocessing comprising:
dividing the volumetric data into overlapping sub-volumes;
generating a set of pre-computed local line integrals for a plurality of directions within each sub-volume; and
storing the pre-computed local line integrals in a look-up table.

4. A method as defined in claim 3, the step of online processing comprising forming the global line integral for each pixel in the DRR image by piecing together the closest local line integrals stored in the look-up table.

5. A method as defined in claim 4, the step of online processing comprising forming the global line integral for each pixel in the DRR image by piecing together interpolated local line integrals stored in the look-up table.

6. A method as defined in- claim 5 wherein the local line integrals are not uniformly spaced in 3D space.

7. A method as defined in claim 6 wherein the local line integrals are sampled more densely in the general direction from which a source radiates through a volume of interest.

8. A method as defined in claim 6 wherein the local line integrals are uniformly spaced in 3D space.

9. A method as defined in claim 7 wherein the amounts of overlap between the blocks are not identical in all directions.

10. A method as defined in claim 8 wherein the amounts of overlap between the blocks and the sizes of the blocks are determined based on the intensity values of the volume, and uniform regions in the volumes have larger blocks with smaller overlaps as opposed to regions with high intensity gradients, which are subdivided into smaller blocks with larger overlaps.

11. A method as defined in claim 9 wherein the amount of overlap is increased in a primary direction perpendicular to the general direction of the rays from a source through a volume of interest.

12. A method as defined in claim 9 wherein fragments of the local line integrals are stored in the form of textures within graphics hardware.

13. A method as defined in claim 4 implemented using the capabilities of the graphics hardware.

14. A method as defined in claim 4 wherein the values of the local line integrals are stored as textures within the graphics hardware for hardware accelerated DRR generation.

15. A method as defined in claim 4, the graphics hardware comprising at least one Graphics Processing Unit.

16. A method as defined in claim 1 wherein the positions and sizes of the subvolumes are adapted to the properties of the volumetric data.

17. A method as defined in claim 1 wherein a hierarchy of blocks having different sizes and overlap amounts is pre-computed and used for DRR reconstructions.

18. A method as defined in claim 1 adapted for rendering transparent volumes.

19. A method as defined in claim 1 wherein each global line integral is pieced together by interpolating the pre-computed local line integrals first among the neighboring subvolumes, and second among the neighboring directions within a subvolume.

20. A system for fast generation of digitally reconstructed radiograph (DRR) images, comprising:
a processor;
an imaging adapter in signal communication with the processor for receiving volumetric data;
a preprocessing unit in signal communication with the processor for preprocessing each of a plurality of subvolumes into a set of local line integrals; and
an online processing unit in signal communication with the processor for online processing global line integrals, each from a set of local line integrals, respectively.

21. A system as defined in claim 20, the preprocessing unit comprising subvolume means for subdividing the volumetric data into a set of overlapping subvolumes; and the online processing unit comprising adding means for adding up values of the set of local line integrals for each global line integral to form pixels of the DRR image.

22. A program storage device readable by machine, tangibly embodying a program of instructions executable by the machine to perform program steps for fast generation of digitally reconstructed radiograph (DRR) images, the program steps comprising:
receiving three-dimensional (3D) volumetric data;
subdividing the 3D volumetric data into a set of overlapping subvolumes;
preprocessing each subvolume into a dense set of local line integrals at a plurality of angles and positions;
online processing global line integrals, each from a set of local line integrals, respectively; and
adding up values of the set of local line integrals for each global line integral to form pixels of the DRR image.
